(19) United States
(12) Patent Application Publication
(10) Pub. No.: US 2003/0165607 A1
(43) Pub. Date: Sep. 4, 2003

(54) Food composition

(76) Inventor: Kari Sipila, Helsinki (FI)

Correspondence Address: BIRCH STEWART KOLASCH & BIRCH, PO BOX 747, FALLS CHURCH, VA, 22040-0747, US

(21) Appl. No.: 10/240,565

(22) PCT Filed: Mar. 27, 2001
(86) PCT No.: PCT/FI01/00296

(30) Foreign Application Priority Data
Apr. 3, 2000 (FI) 20000776

(51) Int. Cl. A23D 7/00

(52) U.S. Cl. 426/601; 426/602

(57) ABSTRACT

The invention relates to a food emulsion containing 10 to 40% of linseeod oil, 0.5 to 20% of linseed press residue, 2 to 25% of protein preparation and 10 to 80%. of water. The composition is particularly usable as a preliminary composition in the production of foodstuffs. The composition increases the beneficial fatty acid composition, fibre content and lignan content of the foodstuff, and thus enhances its health benefits.

### TECHNOLOGICAL BACKGROUND

The invention relates to an emulsion containing oil, fibres and proteins and having beneficial health effects.

Flax (Linum sp.) is a plant cultivated for use as fibres and oil. Oil is separated from flax by pressing or extracting. The separated oil is primarily used in wood preservatives and paints.

Linseed oil is rich in polyunsaturated fatty acids, which, compared to saturated fatty acids, have beneficial health effects in food. The major portion of linseed oil consists of α-linolenic acid (ALA) and α-linolic acid. The ALA concentration of linseed oil is higher than that of any other vegetal oil. On principle, linseed oil would thus be advantageous as alimentary oil. However, due to its high ALA concentration, linseed oil oxidises easily. Also, the taste of linseed oil may seem odd in some foodstuffs.

The press residue of linseed yields linseed groats, which still contain about 4 to 20 percent by weight of linseed oil. If desired, the residual oil can be removed by extracting with a suitable solvent from the groats. Linseed groats are nowadays mainly used as fodder.

Linseed, linseed oil and linseed groats have been separately used or proposed for use in a variety of foods. The use and effects of linseed, linseed oil and linseed groats have been generally described for instance in the publications Carter, Cereal Food World, vol. 38, no 10, 1993, 753-759 and Cui, Canadian Chemical News, vol. 50, no 5, 1998, 19-20.

The taste and colour changes caused by linseed and linseed groats or flour, which are felt unpleasant, set limits to their use in foodstuffs.

### DESCRIPTION OF THE INVENTION

A food composition as defined in claim 1, its production method and use have now been found.

The composition of the invention is an emulsion containing linseed oil, linseed press residue, a protein preparation and water. The composition may also contain some other oil, supplementary fibres, flavour and colour enhancers and other additives for enhanced preservability and physical properties.

The amount of linseed oil added separately to the composition accounts for 10-40%, such as 15 to 30%, especially 20-25% of the weight of the composition. The linseed oil may be obtained especially by pressing, preferably cold pressing. Linseed oil enriches the composition with unsaturated fatty acids that have beneficial health effects, especially α-linolenic acid (ALA). Studies conducted on a mass scale have confirmed that, when such acids account for a larger proportion in the overall fat content of food, there is a smaller risk of cardiovascular diseases. Apparently these acids as such, even without cutting down on other fats, have a preventive effect on cardiovascular diseases.

Besides linseed oil, the composition may contain other vegetal oils, such as rapeseed oil, sunflower oil, soybean oil or olive oil. Especially regarding foodstuffs, in which it is desirable to reduce the taste of flaxseed oil or to increase the taste of some other oil, the addition of some other oil is recommended. In this conjunction, the amount of linseed oil is decreased accordingly from the amount of the formula. Rapeseed oil is particularly useful owing to its neutral taste. The amount of additional oil can account for a maximum of 10% of the weight of the composition.

The amount of linseed press residual in the composition is in the range 0.5 to 20%, such as 1 to 10%, especially 2 to 5%. A linseed press residue obtained by pressing alone may still contain e.g. 4 to 20% of linseed oil. The press residue may be used as such, or it may be subjected to further physical or chemical processing before being used. One such processing operation is further oil removal by extraction. The residue may even be freed of essentially all its oil by these means. Any oil content of the press residue is taken into account in the total oil amount of the formula.

The press residue is a solid substance, which is easy to handle and dose into the composition. Thus, for instance, it is easy to refine the press residue to the desired particle size. Before being used, the press residue may be processed by other means as well in order to modify its properties.

The colour of unprocessed press residue is brown. The press residue may be decoloured, while being deflavoured, defatted and upgraded. Decolouring may be performed for instance as follows: Finely ground linseed groats are humidified with water, the ratio of water to linseed groats varying in the range from 1:1 to 3:1. Enzymes, such as fat-splitting lipases or proteases, may be added to the water. The water is allowed to act on the linseed groats over a period of 0.5 to 12 h, and subsequently the paste-like, aqueous linseed groats are homogenised at room temperature in alcohol, e.g. isopropanol, with the ratio of isopropanol to linseed groats 2-5:1. The homogenised alcoholic suspension is filtered under vacuum or separated from the solution by means of a centrifuge or any other suitable method. The separated groats are washed with a 2-6-fold alcohol amount, the suspension is filtered and centrifuged. The alcoholic groats are dried at 20-90° C. The dried light-coloured groats are ground to a suitable particle size.

About half of the linseed press residue consists of fibres. A fragment rich in fibres, which is usable in the composition of the invention, can be further separated by screening or grading from the residue, especially from decoloured low-fat groats.

A sufficient fibre content in food is a condition for good intestinal activity. Studies on a mass scale have also confirmed that a diet rich in fibres acts as prevention of cardiovascular diseases, cancer of the large intestine, diabetes and also hormonal cancer growth.

Linseed press residue makes food extremely rich in lignans, which have also been found to have very beneficial health effects. Lignins have been especially found to prevent cancer of the large intestine and hormonal cancers. The linseed hull is considerably richer in lignan than other known lignan sources.

Besides press residue, supplementary fibres can be added to the composition. The amount of supplementary fibres may account for 2 to 40%, such as 5 to 25%, especially 7 to 15% of the weight of the composition.

The supplementary fibres may consist of any food fibres suitable for the purpose of use. The fibres may also be soluble. Food fibres suitable for use in foodstuffs are for instance wheat bran, inuline, carboxy methyl cellulose, oat bran, Litesse® and pectin, such as sugar beet pectin. The supplementary fibre ingredient may naturally contain a variety of fibres.

The supplementary fibres may also contain linseed fibres, such as linseed hulls.

Linseed hulls have been found to comprise an intermediate layer particularly rich in lignan. A “ground fraction” particularly rich in lignan and with a high overall fibre content can be separated from whole intact linseed. The ground fraction is separated from the surface portion of whole linseed in a grindstone mill. The coarse surfaces of the grindstones grind the seeds at a specific rate, preferably over a period of about 1 to 3 minutes. Linseed has been found to have a particularly high lignan content after about 1 minute of grinding. The ground fraction can be further decoloured with the method described above.

The amount of protein preparation accounts for 2-25%, such as 5-15%, especially 7-12% of the weight of the composition. The protein preparation may contain vegetable or animal proteins. The source of vegetable proteins may be for instance soybean protein, providing the product with healthy isoflavonoids.

The water amount accounts for 10-80%, such as 20-70%, especially 30-60% of the weight of the composition.

The amount of any enhancers and additives added may account for e.g. 0.5-15%, such as 1-10%, especially 2-7% of the weight of the composition. Possibly used enhancers are selected in view of the desired colour and flavour characteristics. Among possibly used additives we may cite especially antioxidants, which allow better preservation of oils susceptible of oxidation in linseed oil.

In the method of preparation, linseed oil is emulsified by means of a protein preparation to form a homogenous composition. With the oil bound by a protein preparation, the oil is prevented from getting rancid and is better bound to the composition. The amount of water allows the viscosity of the composition to be controlled as desired.

The composition is particularly usable as a preliminary composition in the production of foodstuffs. It can be used to enhance the health benefits of various foodstuffs. With the use of the composition, one can still obtain an end product which has a good taste allied with a nice aspect. It has been found that some foodstuffs to which linseed oil and press residue have been added in this way may contain up to 40 to 200% more of these ingredients than those to which the ingredients have been added separately. The composition is also easy to dose, and its physical properties can be optimised for the purpose of use during production. Preliminary compositions suitable for most varied purposes of use can be achieved by varying the ingredients and their amounts. The composition also yields better water-binding properties.

The emulsion is particularly prepared by admixing dry substances and water with linseed oil, to which colour and flavour enhancers have possibly been added. The admixing is carried out slowly enough for a suitable emulsion to be produced. The water is most preferably as cold as possible.

The composition can also be used as such as a functional preparation.

The foodstuff of the invention may be e.g. a meat product, such as sausage. The foodstuff may also be e.g. a sauce or a ready-made food. We may cite as examples mincemeat products, such as beefburgers and meatballs, lasagne, pizza, filled tortillas, hamburgers, meat pies, microwave dishes, salads, such as salads based on mayonnaise or dressing, and desserts, such as beaten lingonberry porridge and rye lingonberry porridge.

The amount of linseed oil separated from linseed may account for e.g. 0.5 to 20%, such as 1.5 to 6.5% and especially for about 5% in the foodstuff. The amount of press residue may account for e.g. 0.5 to 20%, such as 1 to 10%, and especially 2 to 5% in the foodstuff. The amount of supplementary fibres may account for e.g. 0.5 to 19.5%, such as 1 to 10% and especially 2 to 5% in the foodstuff.

The sausage paste may contain e.g. 3 to 10% of linseed oil, 0.5 to 4% of linseed groats and e.g. 1 to 7% of supplementary fibres. The supplementary fibres may be e.g. wheat fibres and/or inulin.

The amount of linseed fibres varies in different foodstuffs, given their different flavour, texture and colour effects. If decoloured groats, decoloured ground fraction or decoloured lignan-enriched fraction is used, the addition may be considerably greater than that of an unprocessed fraction, even twice the addition to an unprocessed fraction.

The method described above can be used to prepare various functional foods, whose health benefit consist in lower cholesterol level or better intestinal activities. The foodstuff of the invention is particularly based on a foodstuff that is typically rich in saturated fatty acids and poor in fibres.

The use of the composition of the invention allows the preparation of a foodstuff, especially a meat product or ready-made food, which provides an optimal combination of the good properties of linseed oil and linseed fibres, while preserving the good quality of the food. In accordance with the invention, a product is obtained that combines an increased fibre content with a notably healthier fat composition than do similar conventional foodstuffs. The invention yields a product which basically resembles the corresponding conventional product in taste, texture and colour, and which does not involve the unfavourable colour and flavour usually associated with linseed.

In accordance with the invention, the water and fat-binding properties of the product are also enhanced. This is an advantage especially in meat preparations, such as sausages.

In accordance with the invention, optimal oil and fibre composition is easy to achieve for each product.

### EXAMPLE

The composition of an emulsion intended for the production of sausage paste may be as follows:

20% Linseed oil

5% Flavour enhancers and antioxidants

10% Wheat fibres

5% Linseed groats

5% Inulin

10% Protein preparation

45% Water

A cutter is started at low rotational speed. Linseed oil and flavour enhancers are added in the cutter. The remaining dry substances are added during addition of cold, iced water. The cutter is operated at high rotational speed. The overall cutter operation period is 2 to 4 minutes. The final temperature is 10 to 20° C.

The analytic limits values of the paste are as follows:

Humidity 50%

Fat 28%

Protein 18%

1. A food composition, characterised in being an emulsion that contains 10 to 40% by weight of linseed oil, 0.5 to 20% by weight of linseed press residue, 2 to 25% by weight of protein preparation and 10 to 80% by weight of water.

2. A method for preparing the food composition defined in claim 1, characterised in that linseed press residue and water are admixed with linseed oil.

3. A method for preparing a food composition, characterised in that a food composition of claim 1 or prepared as in claim 2 is added to substances usable as foodstuffs.

4. A method for enhancing the beneficial health effects of a foodstuff, characterised in that a food composition of claim 1 or prepared as in claim 2 is added to a foodstuff.
